(19) United States
(12) Patent Application Publication
(10) Pub. No.: US 2011/0032278 A1
(43) Pub. Date: Feb. 10, 2011

(54) SOURCE DRIVER

(75) Inventors: Li-Chun Huang, Yunlin County (TW); Jin-Sheng Hsieh, Hsinchu County (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., Hsinchu (TW)

(21) Appl. No.: 12/683,635

(22) Filed: Jan. 7, 2010

(30) Foreign Application Priority Data
Aug. 6, 2009 (TW) 098126620

(51) Int. Cl. G09G 5/10

(52) U.S. Cl. 345/690

(57) ABSTRACT

A source driver including a data register, a level shifter, a gamma correction unit, a digital-to-analog converter and a buffer is provided. The data register stores a digital data signal. The level shifter pulls up the level of the digital data signal. The gamma correction unit provides a gamma curve. The digital-to-analog converter transforms the level-pulled-up digital data signal into an analog data signal with reference to the gamma curve. The buffer outputs the analog data signal to drive a corresponding data line. The level shifter, the gamma correction unit, the digital-to-analog converter and the buffer are all figured to receive a first set of reference voltages or a second set of reference voltages.

This application claims the benefit of Taiwan application Serial No. 98126620, filed Aug. 6, 2009, the subject matter of which is incorporated herein by reference.

### BACKGROUND OF THE INVENTION

1. Field of the Invention

The invention relates in general to a source driver, and more particularly to a cost-saving source driver.

2. Description of the Related Art

The liquid crystal molecules cannot be fixed at a particular level of voltage, otherwise liquid crystal molecules whose properties are destroyed cannot be rotated to form different grey levels in response to the change in electrical field. Thus, when driving liquid crystal molecules, the voltage must be changed every period of time to provide two voltages with positive and negative polarities to achieve polarity inversion. Normally, the source driver of the liquid crystal display has many forms of polarity inversion to drive liquid crystal molecules so as to achieve the dot inversion producing better display quality or the line inversion driving consuming less power.

Presumably, the polarity inversion is achieved by line inversion. As the driving voltages are with the same polarity at the same time, the source driver can achieve polarity inversion by means of the inversion between the common voltage and the data voltage. Presumably, the polarity inversion is achieved by dot inversion. As the driving voltages are with different polarities at the same time (that is, a half of the source drivers outputs the driving voltage with positive polarity and the other half of the source drivers outputs the driving voltage with negative polarity), the source driver must rely on the fixed common voltage to achieve polarity inversion by changing the data voltage to be higher or lower than the common voltage. Thus, the voltage output range of the source driver driven by dot inversion is twice than that driven in line inversion. Referring to FIG. 1A and FIG. 1B, a transmittance to driving voltage relationship curve of the line-inverted and the dot-inverted liquid crystal molecules is shown. That is, due to different voltage output ranges, dot inversion and line inversion cannot co-exist in the conventional integrated circuit (IC).

### SUMMARY OF THE INVENTION

The invention is directed to a source driver, which integrates polarity inversion characteristics such as dot inversion and line inversion on the same integrated circuit (IC) by switching the reference voltage, further expanding the application of the single integrated circuit.

According to a first aspect of the present invention, a source driver including a data register, a level shifter, a gamma correction unit, a digital-to-analog converter and a buffer is provided. The data register stores a digital data signal. The level shifter selectively receives a first set of reference voltages or a second set of reference voltages so as to pull up the level of the digital data signal. The gamma correction unit selectively receives the first set of reference voltages or the second set of reference voltages so as to provide a gamma curve. The digital-to-analog converter selectively receives the first set of reference voltages or the second set of reference voltages, and transforms the level-pulled-up digital data signal into an analog data signal with reference to the gamma curve. The buffer selectively receives the first set of reference voltages or the second set of reference voltages so as to output the analog data signal to drive a corresponding data line. The level shifter, the gamma correction unit, the digital-to-analog converter and the buffer are all figured to receive the first set of reference voltages or the second set of reference voltages.

According to a second aspect of the present invention, a source driver including a data register, a level shifter, a gamma correction unit, a buffer and a digital-to-analog converter is provided. The data register stores a digital data signal. The level shifter selectively receives a first set of reference voltages or a second set of reference voltages so as to pull up the level of the digital data signal. The gamma correction unit selectively receives the first set of reference voltages or the second set of reference voltages so as to provide a gamma curve. The buffer selectively receives the first set of reference voltages or the second set of reference voltages, and outputs the level-pulled-up digital data signal with reference to the gamma curve. The digital-to-analog converter selectively receives the first set of reference voltages or the second set of reference voltages so as to transform the digital data signal into an analog data signal to drive a corresponding data line. The level shifter, the gamma correction unit, the buffer and the digital-to-analog converter are all figured to receive the first set of reference voltages or the second set of reference voltages.

The invention will become apparent from the following detailed description of the preferred but non-limiting embodiments. The following description is made with reference to the accompanying drawings.

### BRIEF DESCRIPTION OF THE DRAWINGS

FIG. 1A and FIG. 1B respectively a transmittance to driving voltage relationship curve of the line-inverted and the dot-inverted liquid crystal molecules;

FIG. 2A and FIG. 2B show a source driver according to a first embodiment of the invention; and

FIG. 3A and FIG. 3B show a source driver according to a second embodiment of the invention.

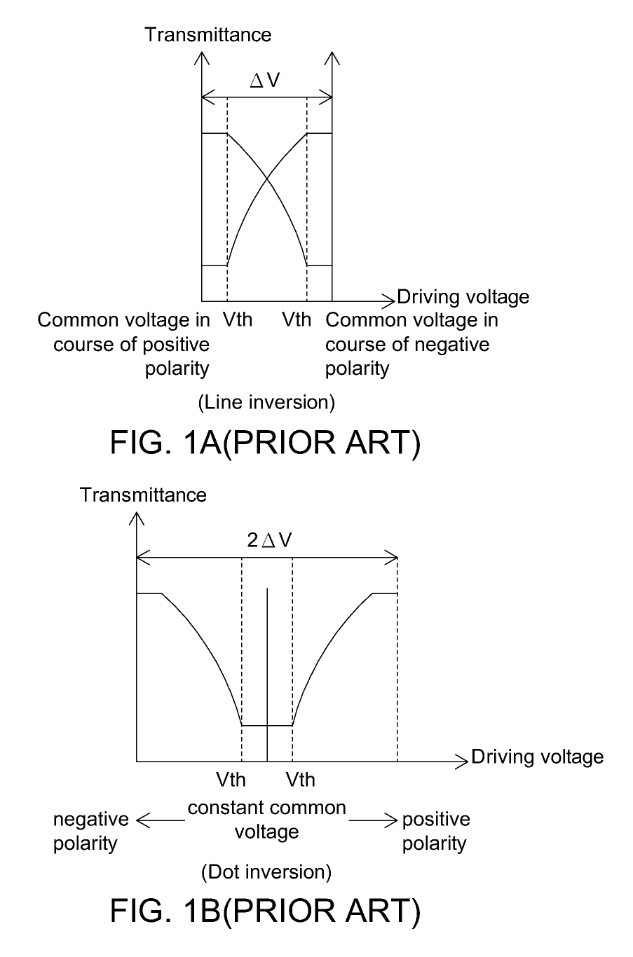

### DETAILED DESCRIPTION OF THE INVENTION

The invention provides a source driver, which integrates polarity inversion characteristics such as dot inversion and line inversion on the same integrated circuit (IC) by switching the reference voltage without changing existing manufacturing process or developing new manufacturing process, further expanding the application of the single integrated circuit.

### First Embodiment

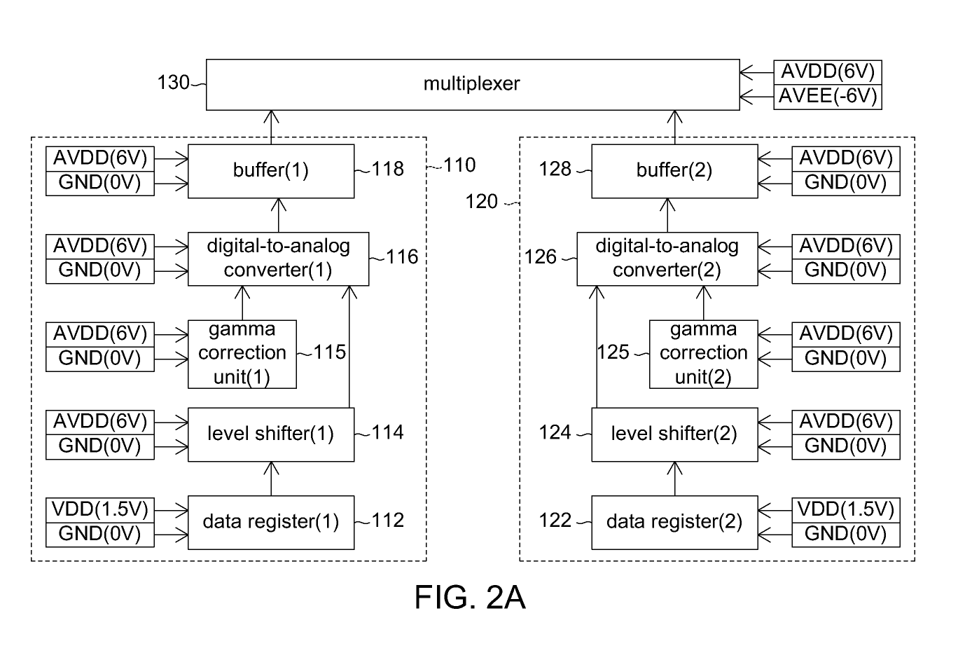

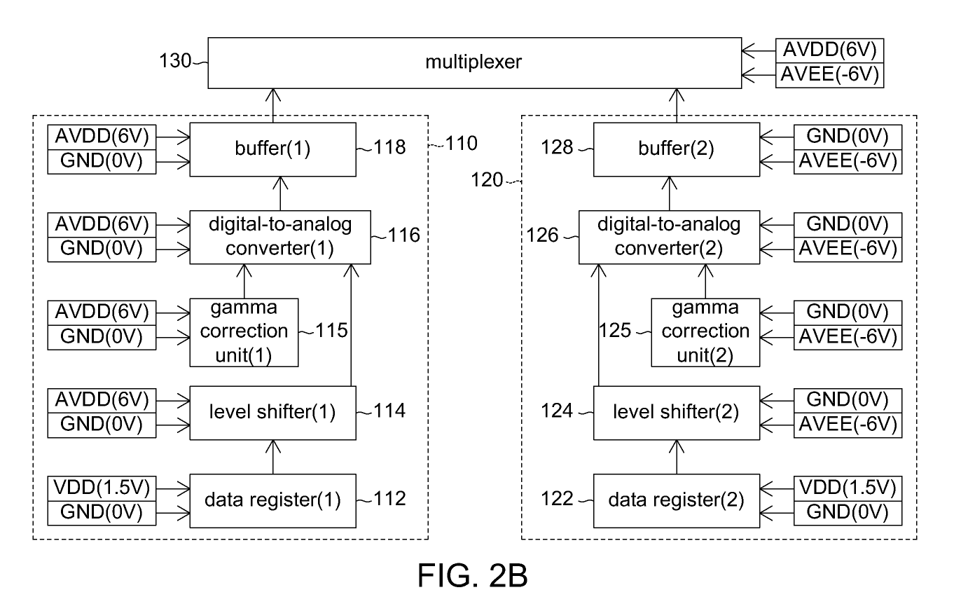

Referring to FIG. 2A and FIG. 2B, a source driver according to a first embodiment of the invention is shown. The source driver 110 includes a data register (1) 112, a level shifter (1) 114, a gamma correction unit (1) 115, a digital-to-analog converter (1) 116 and a buffer (1) 118. The source driver 120 includes a data register (2) 122, a level shifter (2) 124, a gamma correction unit (2) 125, a digital-to-analog converter (2) 126 and a buffer (2) 128.

In FIG. 2A, the source drivers 110 and 120 drive liquid crystal molecules by way of line-inverted polarity inversion. The level shifter (1) 114, the gamma correction unit (1) 115, the digital-to-analog converter (1) 116 and the buffer (1) 118 of the source driver 110 are all figured to receive the first set of reference voltages GND (0V)˜AVDD (6V) before the IC on which the source driver 110 is disposed is delivered from the factory. Besides, before the IC on which the source driver 110 is disposed is delivered from the factory, the level shifter (2) 124, the gamma correction unit (2) 125, the digital-to-analog converter (2) 126 and the buffer (2) 128 of the source driver 120 can be all figured to receive the first set of reference voltages GND (0V)˜AVDD (6V) by way of high pressure component, medium pressure component or by bonding the pads to different electric potentials during the layout process.

The data register (1) 112 stores a digital data signal. The level shifter (1) 114 pulls up the level of the digital data signal according to the first set of reference voltages GND (0V)˜AVDD (6V). The gamma correction unit (1) 115 provides a gamma curve according to the first set of reference voltages GND (0V)˜AVDD (6V). The digital-to-analog converter (1) 116 transforms the level-pulled-up digital data signal into an analog data signal according to the first set of reference voltages GND (0V)˜AVDD (6V) with reference to the gamma curve. The buffer (1) 118 outputs the analog data signal Out (1) to drive the corresponding data line according to the first set of reference voltages GND (0V)˜AVDD (6V).

The data register (2) 122 stores a digital data signal. The level shifter (2) 124 pulls up the level of the digital data signal according to the first set of reference voltages GND (0V)˜AVDD (6V). The gamma correction unit (2) 125 provides a gamma curve according to the first set of reference voltages GND (0V)˜AVDD (6V). The digital-to-analog converter (2) 126 transforms the level-pulled-up digital data signal into an analog data signal according to the first set of reference voltages GND (0V)˜AVDD (6V) with reference to the gamma curve. The buffer (2) 128 outputs the analog data signal Out (2) to drive the corresponding data line according to the first set of reference voltages GND (0V)˜AVDD (6V).

In FIG. 2A, the source drivers 110 and 120 both receive the first set of reference voltages GND (0V)˜AVDD (6V), so the analog data signals Out (1) and Out (2) are data signals with the same polarity. As the driving voltages are with the same polarity at the same time, the source drivers 110 and 120 can drive liquid crystal molecules by way of line-inverted polarity inversion.

In FIG. 2B, the source drivers 110 and 120 drive liquid crystal molecules by way of dot-inverted polarity inversion. The level shifter (1) 114, the gamma correction unit (1) 115, the digital-to-analog converter (1) 116 and the buffer (1) 118 of the source driver 110 are all figured to receive the first set of reference voltages GND (0V)˜AVDD (6V). Besides, before the IC on which the source driver 110 is disposed is delivered from the factory, the level shifter (2) 124, the gamma correction unit (2) 125, the digital-to-analog converter (2) 126 and the buffer (2) 128 of the source driver 120 can all be switched and figured to receive the second set of reference voltages AVEE (−6V)˜GND (0V) by way of high pressure component, medium pressure component or by bonding the pads to different electric potentials during the layout process.

The data register (1) 112 stores a digital data signal. The level shifter (1) 114 pulls up the level of the digital data signal according to the first set of reference voltages GND (0V)˜AVDD (6V). The gamma correction unit (1) 115 provides a gamma curve according to the first set of reference voltages GND (0V)˜AVDD (6V). The digital-to-analog converter (1) 116 transforms the level-pulled-up digital data signal into an analog data signal with reference to the gamma curve according to the first set of reference voltages GND (0V)˜AVDD (6V). The buffer (1) 118 outputs the analog data signal Out (1) to drive the corresponding data line according to the first set of reference voltages GND (0V)˜AVDD (6V).

The data register (2) 122 stores a digital data signal. The level shifter (2) 124 pulls up the level of the digital data signal according to the second set of reference voltages AVEE (−6V)˜GND (0V). The gamma correction unit (2) 125 provides a gamma curve according to the second set of reference voltages AVEE (−6V)˜GND (0V). The digital-to-analog converter (2) 126 transforms the level-pulled-up digital data signal into an analog data signal with reference to the gamma curve according to the second set of reference voltages AVEE (−6V)˜GND (0V). The buffer (2) 128 outputs the analog data signal Out (2) to drive the corresponding data line according to the second set of reference voltages AVEE (−6V)˜GND (0V).

In FIG. 2B, the source drivers 110 and 120 respectively receive different reference voltage, so the analog data signals Out (1) and Out (2) are data signals with different polarities. As the driving voltages are with different polarities, so the source drivers 110 and 120 can drive liquid crystal molecules by way of dot-inverted polarity inversion, and the multiplexer 130 can be used for full-time driving so as to increase the efficiency of use of the IC.

### Second Embodiment

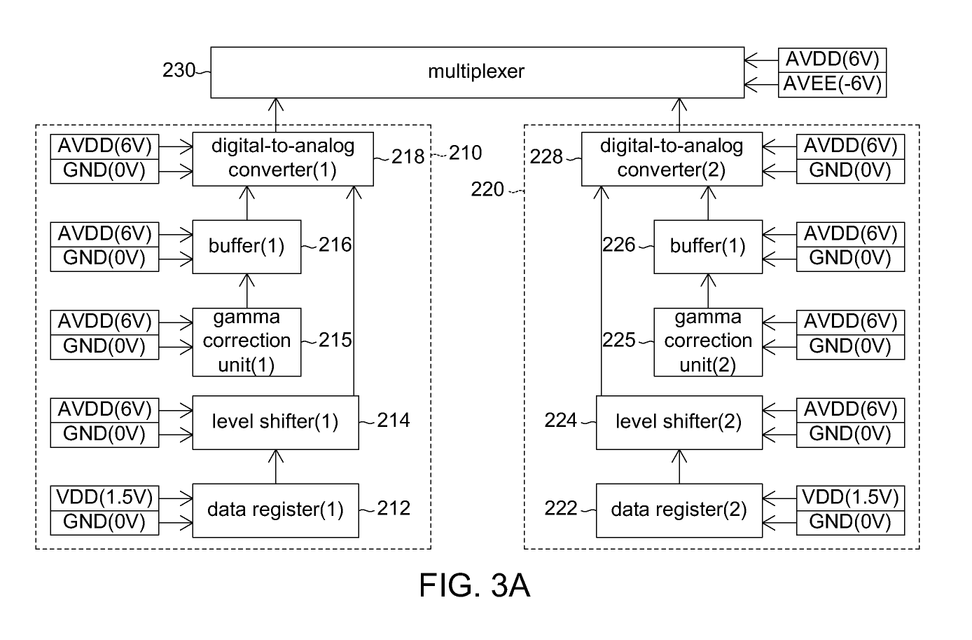

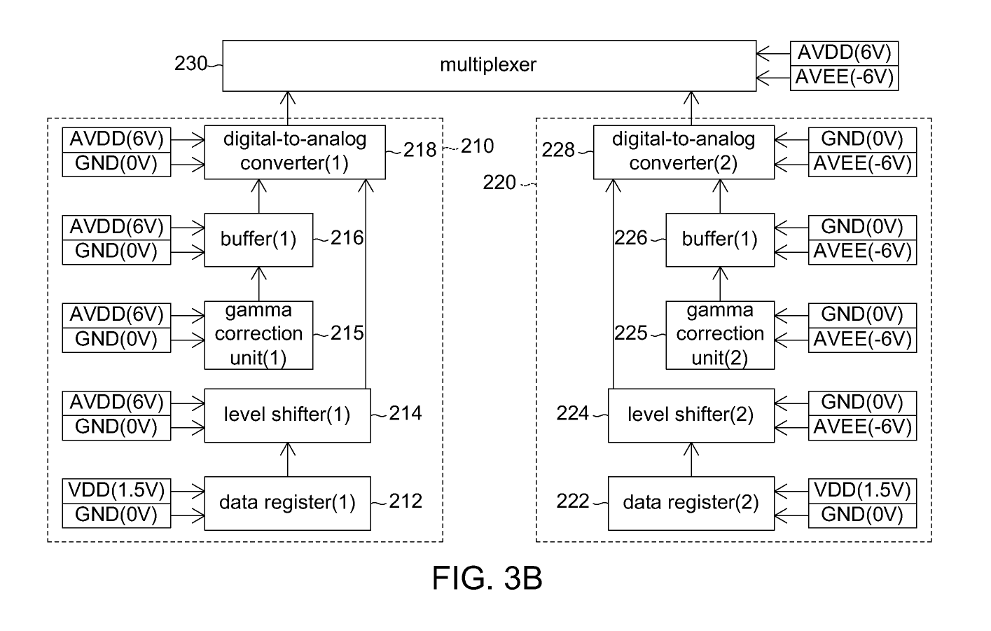

Referring to FIG. 3A and FIG. 3B, a source driver according to a second embodiment of the invention is shown. The source driver 210 includes a data register (1) 212, a level shifter (1) 214, a gamma correction unit (1) 215, a buffer (1) 216 and a digital-to-analog converter (1) 218. The source driver 220 includes a data register (2) 222, a level shifter (2) 224, a gamma correction unit (2) 225, a buffer (2) 226 and a digital-to-analog converter (2) 228.

In FIG. 3A, the source drivers 210 and 220 drive liquid crystal molecules by way of line-inverted polarity inversion. The level shifter (1) 214, the gamma correction unit (1) 215, the buffer (1) 216 and the digital-to-analog converter (1) 218 of the source driver 210 re all figured to receive the first set of reference voltages GND (0V)˜AVDD (6V) before the IC on which the source driver 210 is disposed is delivered from the factory. Besides, before the IC on which the source driver 210 is disposed is delivered from the factory, the level shifter (2) 224, the gamma correction unit (2) 225, the buffer (2) 226 and the digital-to-analog converter (2) 228 of the source driver 220 can be all figured to receive the first set of reference voltages GND (0V)˜AVDD (6V) by way of high pressure component, medium pressure component or by bonding the pads to different electric potentials during the layout process.

The data register (1) 212 stores a digital data signal. The level shifter (1) 214 pulls up the level of the digital data signal according to the first set of reference voltages GND (0V)˜AVDD (6V). The gamma correction unit (1) 215 provides a gamma curve according to the first set of reference voltages GND (0V)˜AVDD (6V). The buffer (1) 216 outputs the level-pulled-up digital data signal according to the first set of reference voltages GND (0V)˜AVDD (6V) with reference to the gamma curve. The digital-to-analog converter (1) 218 transforms the digital data signal into an analog data signal Out (1) to drive the corresponding data line according to the first set of reference voltages GND (0V)˜AVDD (6V).

The data register (2) 222 stores a digital data signal. The level shifter (2) 224 pulls up the level of the digital data signal according to the first set of reference voltages GND (0V)˜AVDD (6V). The gamma correction unit (2) 225 provides a gamma curve according to the first set of reference voltages GND (0V)˜AVDD (6V). The buffer (2) 226 outputs the level-pulled-up digital data signal according to the first set of reference voltages GND (0V)˜AVDD (6V) with reference to gamma curve. The digital-to-analog converter (2) 228 transforms the digital data signal into an analog data signal Out (2) to drive the corresponding data line according to the first set of reference voltages GND (0V)˜AVDD (6V).

In FIG. 3A, the source drivers 210 and 220 both receive the first set of reference voltages GND (0V)˜AVDD (6V), so the analog data signals Out (1) and Out (2) are data signals with the same polarity. As the driving voltages are with the same polarity at the same time, the source drivers 210 and 220 can drive liquid crystal molecules by way of line-inverted polarity inversion

In FIG. 3B, the source drivers 210 and 220 drive liquid crystal molecules by way of dot-inverted polarity inversion. The level shifter (1) 214, the gamma correction unit (1) 215, the digital-to-analog converter (1) 216 and the buffer (1) 218 of the source driver 210 are all figured to receive the first set of reference voltages GND (0V)˜AVDD (6V) before the IC on which the source driver 210 is disposed is delivered from the factory. Besides, the level shifter (2) 224, the gamma correction unit (2) 225, the digital-to-analog converter (2) 226 and the buffer (2) 128 of the source driver 220 can all be switched and figured to receive the second set of reference voltages AVEE (−6V)˜GND (0V) by way of high pressure component, medium pressure component or by bonding the pads to different electric potentials during the layout process before the IC on which the source driver 210 is disposed is delivered from the factory.

The data register (1) 212 stores a digital data signal. The level shifter (1) 214 pulls up the level of the digital data signal according to the first set of reference voltages GND (0V)˜AVDD (6V). The gamma correction unit (1) 215 provides a gamma curve according to the first set of reference voltages GND (0V)˜AVDD (6V). The buffer (1) 216 outputs the level-pulled-up digital data signal according to the first set of reference voltages GND (0V)˜AVDD (6V) with reference to the gamma curve. The digital-to-analog converter (1) 218 transforms the digital data signal into an analog data signal Out (1) to drive the corresponding data line according to the first set of reference voltages GND (0V)˜AVDD (6V).

The data register (2) 222 stores a digital data signal. The level shifter (2) 224 pulls up the level of the digital data signal according to the second set of reference voltages AVEE (−6V)˜GND (0V). The gamma correction unit (2) 225 provides a gamma curve according to the second set of reference voltages AVEE (−6V)˜GND (0V). The buffer (2) 226 outputs the level-pulled-up digital data signal according to the second set of reference voltages AVEE (−6V)˜GND (0V) with reference to the gamma curve. The digital-to-analog converter (2) 228 transforms the digital data signal into an analog data signal Out (2) to drive the corresponding data line according to the second set of reference voltages AVEE (−6V)˜GND (0V).

In FIG. 3B, the source drivers 210 and 220 respectively receive different reference voltage, so the analog data signals Out (1) and Out (2) are data signals with different polarities. As the driving voltages are with different polarities, so the source drivers 210 and 220 can drive liquid crystal molecules by way of dot-inverted polarity inversion, and the multiplexer 230 can be used for full-time driving so as to increase the efficiency of use of the IC.

The source driver disclosed in the above embodiments of the invention has many advantages exemplified below:

The source driver of the invention switches the reference voltage by way of by way of high pressure component, medium pressure component or by bonding the pads to different electric potentials during the layout process, and can be integrated on one single IC without changing the polarity inversion such as dot inversion and line inversion or developing new manufacturing process, further expanding the application of the single integrated circuit. As the manufacturers do not need to fabricate different ICs, the risk of inventory loss is reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A source driver, comprising:
a data register for storing a digital data signal;
a level shifter for selectively receiving a first set of reference voltages or a second set of reference voltages so as to pull up the level of the digital data signal;
a gamma correction unit for selectively receiving the first set of reference voltages or the second set of reference voltages so as to provide a gamma curve;
a digital-to-analog converter for selectively receiving the first set of reference voltages or the second set of reference voltages, and transforming the level-pulled-up digital the digital data signal into an analog data signal with reference to the reference the gamma curve; and
a buffer for selectively receiving the first set of reference voltages or the second set of reference voltages so as to output the analog data signal to drive a corresponding data line;
wherein, the level shifter, the gamma correction unit, the digital-to-analog converter and the buffer are all figured to receive the first set of reference voltages or the second set of reference voltages.

2. The source driver according to claim 1, wherein if the level shifter, the gamma correction unit, the digital-to-analog converter and the buffer are all figured to receive the first set of reference signals, then the analog data signal is an output signal with positive polarity.

3. The source driver according to claim 1, wherein if the level shifter, the gamma correction unit, the digital-to-analog converter and the buffer are all figured to receive the second set of reference signals, then the analog data signal is an output signal with negative polarity.

4. A source driver, comprising:
a data register for storing a digital data signal;
a level shifter for selectively receiving a first set of reference voltages or a second set of reference voltages so as to pull up the level of the digital data signal;
a gamma correction unit for selectively receiving the first set of reference voltages or the second set of reference voltages so as to provide a gamma curve;
a buffer for selectively receiving the first set of reference voltages or the second set of reference voltages, and outputting the level-pulled-up digital the digital data signal with reference to the gamma curve; and
a digital-to-analog converter for selectively receiving the first set of reference voltages or the second set of reference voltages so as to transform the digital data signal into an analog data signal to drive a corresponding data line;
wherein, the level shifter, the gamma correction unit, the buffer and the digital-to-analog converter are all figured to receive the first set of reference voltages or the second set of reference voltages.

5. The source driver according to claim 4, wherein if the level shifter, the gamma correction unit, the buffer and the digital-to-analog converter are all figured to receive the first set of reference signals, then the analog data signal is an output signal with positive polarity.

6. The source driver according to claim 4, wherein if the level shifter, the gamma correction unit, the buffer and the digital-to-analog converter are all figured to receive the second set of reference signals, then the analog data signal is an output signal with negative polarity.
